(19) United States
(12) Patent Application Publication
(10) Pub. No.: US 2014/0097364 A1
(43) Pub. Date: Apr. 10, 2014

(54) ADJUSTABLE DIAPHRAGM RETAINER PLATE

(71) Applicant: ARRAY HOLDINGS, INC., Houston, TX (US)

(72) Inventor: Terry Glenn Young, Longview, TX (US)

(73) Assignee: Array Holdings, Inc., Houston, TX (US)

(21) Appl. No.: 13/648,388

(22) Filed: Oct. 10, 2012

(51) Int. Cl. F16K 31/126

(52) U.S. Cl. CPC F16K 31/1262
USPC 251/61; 29/890.12

(57) ABSTRACT

Disclosed herein are improved diaphragm actuators capable of preventing the inhibition of movement of a diaphragm retainer plate when a stretched or improperly sized diaphragm is used. Such diaphragm retainer plates may be adjustable such that the thickness from the distal side to the proximal side is increased. Methods of preventing such inhibition of movement are also disclosed.

### FIELD

The present invention relates generally to valve actuators. More particularly the present invention relates to a valve actuator having improved adjustment ability in order to compensate for diaphragm size.

### BACKGROUND

A valve is a device that regulates the flow of a substance. Valves are produced in a variety of different styles, shapes and sizes. Typically, valves are used for gases and liquids. However, valves are also used on solids capable of flow, slurries or any other substance capable of flow. Valves are used in almost every industry having a substance that flows.

One type of valve is a gate valve, also referred to as a sluice valve. A gate valve opens by moving a blocking element from the path of flow. The blocking element may be a round disk, a rectangular element, or a wedge. Gate valves have a blocking element and a seat forming a substantially leak proof seal. In a gate valve, the blocking element can be referred to as a gate valve block, a gate block or a block. In the open position, a gate valve has a bore where the substance is allowed to partially or completely flow through the valve. In a gate valve, the bore may be referred to a gate valve bore. When the gate valve bore is across the valve bore the gate valve is in an open position. When the gate valve block is across the valve bore, the gate valve is in a closed position.

Gate valves may be operated manually or automatically. One method to automatically operate a gate valve is to use an actuator. An actuator is a mechanical device for moving or controlling a mechanism or system. When an actuator is used in a gate valve, the actuator is typically linked to a stem to repeatedly move the valve gate between open and closed positions.

Actuators to open and close the gate valves may include manual operators, diaphragm-type operators, pneumatic operators and hydraulic operators. Often, a manual operator is combined with a manual operator with a diaphragm-type, pneumatic or hydraulic operator for back-up and test purposes. Additionally, the actuator may include a bonnet assembly, which interconnects the valve body and the valve gate, and a bonnet stem which is movable with the gate via an operator.

Diaphragm actuators are popular for use with valves due to dependability. These actuators generally have a housing containing a diaphragm, an operator stem and one or more springs. The operator stem may include a joined top stem in some designs, while in other designs; the top stem and operator stem are separate. In general, an end portion of the top stem passes through the central hole or aperture of the diaphragm in such actuators. Generally, a diaphragm retaining nut with a central aperture will be slid down the top stem such that the diaphragm retaining nut presses against and retains the diaphragm against a diaphragm retainer plate. Thus in such designs the diaphragm retaining nut and the diaphragm retainer plate sandwich the diaphragm. In this case, the movement of the diaphragm due to pressurization of one chamber of the diaphragm actuator housing will cause corresponding movement of the top stem. Typically, the diaphragm aperture is sealed to prevent pressure loss between the upper housing and the lower housing. Techniques known in the art to seal the diaphragm aperture include seals, washers, O-rings and the like.

In certain instances, such as due to the pressurization of the upper chamber of a diaphragm actuator, the diaphragm is pulled or subject to increased tensile loading. Such stresses can lead to a stretching of the diaphragm material which can then complicate further pressurization or ability to open or close a valve.

Additionally, many different sizes of diaphragms exist. A disadvantage with valve actuators with diaphragms is that the diaphragms can stretch around the diaphragm retainer plate and prevent actuator operation as the diaphragm is typically a flexible material sandwiched between a top and bottom diaphragm housing fastened together by tightening several fasteners.

It would be beneficial to have a valve actuator with an adjustable diaphragm retainer plate to overcome the obstacles associated with stretched diaphragms and mismatched diaphragms.

A more secure diaphragm and diaphragm retaining device on a valve actuator may be desirable to overcome these obstacles.

### SUMMARY

Certain embodiments of the invention pertain to a diaphragm actuator with a top actuator housing connected to a lower actuator housing for moving a gate valve, wherein the valve actuator moves the gate between an opened and a closed position within a valve body, and wherein the valve actuator comprises: a pressure chamber and an inlet port formed in the top actuator housing; a top shaft, wherein the top shaft extends through the top actuator housing and is operatively connected to a diaphragm retainer plate, the top shaft defining a shaft axis; a diaphragm that applies pressure against a diaphragm retainer plate, and wherein the diaphragm further comprising a pressure side that engages the diaphragm retainer plate, and an atmospheric side opposite the pressure side, the diaphragm at least partially surrounding the top shaft; a diaphragm retainer plate with a proximal side, a distal side and having an outwardly facing edge defining a circumference; a diaphragm retainer plate wall connected to the proximal side of the diaphragm retainer plate and at least partially wrapping around the circumference, the diaphragm retainer plate wall having a proximal end, an outwardly facing side and an inwardly facing side, the inwardly facing side being adapted to receive an extender ring; an extender ring with a proximal end, a distal end, and an outwardly facing wall abutting the inwardly facing side of the diaphragm retainer plate wall; and wherein extender ring is capable of moving in a proximal direction or distal direction relative to the diaphragm retainer wall and is capable of extending in a direction further proximal than the proximal end of the diaphragm retainer plate wall.

In certain embodiments pertaining to the diaphragm retainer plate wall, the inwardly facing wall of the diaphragm retainer plate wall is threaded and adapted to receive a threaded outwardly facing wall of the extender ring. In such embodiments, the extender ring moves in a proximal direction or distal direction relative to the diaphragm retainer plate wall by rotation of the extender ring. Still further, a lip may be attached to the proximal end of the retainer ring such that the circumference of the lip is about equal to that of the diaphragm retainer plate.

In other embodiments, in lieu of an inwardly facing threaded diaphragm retainer plate wall and an outwardly facing threaded extender wall, the diaphragm retainer plate wall may have threaded bores substantially perpendicular to the shaft axis and the inwardly facing wall so that they are adapted to receive an outwardly facing wall of the extender ring. In such embodiments, the extender ring may have a plurality of vertically grouped bores, with one bore of each group being capable of alignment with a threaded bore of the diaphragm retainer plate wall, and wherein the extender ring is capable of being secured to the diaphragm retainer plate wall by threaded bolts traversing at least one bore of the extender ring and being threaded into the threaded bore of the diaphragm retainer plate wall. Still further, in lieu of a plurality of vertically grouped bores, the extender ring may have a plurality of vertical slits serving a similar function.

Additional embodiments of the invention pertain to a diaphragm actuator with a top actuator housing connected to a lower actuator housing for moving a gate valve, wherein the valve actuator moves the gate between an opened and a closed position within a valve body, and wherein the valve actuator comprises: a pressure chamber and an inlet port formed in the top actuator housing; a top shaft, wherein the top shaft extends through the top actuator housing and is operatively connected to a diaphragm retainer plate, the top shaft defining a shaft axis; a diaphragm that applies pressure against a diaphragm retainer plate, and wherein the diaphragm further comprising a pressure side that engages the diaphragm retainer plate, and an atmospheric side opposite the pressure side, the diaphragm at least partially surrounding the top shaft; a diaphragm retainer plate with a proximal side, a distal side and having an outwardly facing edge defining a circumference; a diaphragm retainer plate wall having a thickness and connected to the proximal side of the diaphragm retainer plate and at least partially wrapping around the circumference, the diaphragm retainer plate wall having a proximal end, the proximal end having threaded bores extending distally into the thickness of the diaphragm retainer plate wall; an extender lip abutting the diaphragm retainer plate wall, the extender lip having a proximal side, a distal side, and extender lip bores extending from the proximal side of the extender lip to the distal side of the extender lip, wherein the bores are in alignment with the threaded bores of the diaphragm retainer plate wall; and wherein threaded bolts extend through the extender lip bores and into the threaded bores of the diaphragm retainer plate wall, thereby securing the distal side of the extender lip to the proximal end of the diaphragm retainer plate wall.

In the aforementioned embodiment, the threaded bolts may be loosened such that the extender plate moves to a more proximal location thereby no longer abutting the diaphragm retainer plate wall.

Other embodiments of the invention pertain to a diaphragm actuator wherein the diaphragm retainer plate has a proximal side and a distal side and with a threaded outwardly facing wall, the wall adapted to receive a retainer ring with a threaded inwardly facing wall, wherein rotation of the retainer ring moves the retainer ring in a proximal or distal direction relative to the diaphragm retainer plate.

Still further, certain embodiments of the invention concern methods preventing a diaphragm in a diaphragm actuator from inhibiting movement of a diaphragm retainer plate when the actuator is pressurized. Such a method may include the installation of a diaphragm retainer plate having any of the aforementioned configurations, such as an extender ring, an extender lip or a retainer ring.

In the embodiments of the method, when using one of the aforementioned methods, after repressurizing the actuator, the diaphragm no longer contacts the proximal side of the diaphragm retainer plate, thereby allowing the diaphragm retainer plate to move in a proximal direction.

### BRIEF DESCRIPTION OF THE DRAWINGS

FIG. 1 is a cross sectional illustration of a diaphragm retainer plate of the present invention.

FIG. 2 is another cross sectional illustration of a diaphragm retainer plate of the present invention with horizontal bolts securing an extender ring against the diaphragm retainer plate wall.

FIG. 3 is another cross sectional illustration of a diaphragm retainer plate of the present invention with vertical bolts securing an extender lip against the proximal side of a diaphragm retainer plate wall.

FIG. 4 is half of a cross sectional illustration of a diaphragm retainer plate with a threaded outward wall and a retainer ring with a threaded interior wall surrounding the retainer plate.

FIG. 5 is a cross sectional illustration of a diaphragm actuator.

### LIST OF REFERENCE NUMERALS

diaphragm retainer plate 10
top shaft threaded bore 20
diaphragm retainer plate wall 30
extender ring 40
lip 50
vertically grouped bores 60
retainer plate wall bore 70
vertical retainer wall threaded bores 80
vertical extender ring bores 90
extender lip 100
vertical bolts 110
diaphragm retainer plate ring 120
actuator 200
top actuator housing 205
lower actuator housing 210
actuator bolts 215
inlet port 220
pressure relief valve 225
upper plug 230
top shaft 235
diaphragm 240
diaphragm retaining nut 245
actuator access holes 247
operator shaft 250
downstop 255
central spring 260
bonnet ring 265
bonnet 270
packing retainer 275

### DETAILED DESCRIPTION

### Introduction

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings making apparent to those skilled in the art how the several forms of the invention may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3rd Edition.

Distal, in certain instances, can be defined as toward the top of the actuator and away from any valve on which the actuator rests.

Proximal, in certain instances, can be defined as toward a valve on which an actuator is mounted and away from the top of the actuator.

Inward or inwardly, in certain instances, can be defined as toward a central axis in a direction substantially perpendicular to such a central axis.

Outward or outwardly, in certain instances, can be defined as away from a central axis in a direction substantially perpendicular to such a central axis.

As used herein, the term “conduit” means and refers to a fluid flow path.

As used herein, the term “line” means and refers to a fluid flow path.

As used herein, the term “fluid” refers to a non-solid material such as a gas, a liquid or a colloidal suspension capable of being transported through a pipe, line or conduit. Examples of fluids include by way of non-limiting examples the following: natural gas, propane, butane, gasoline, crude oil, mud, water, nitrogen, sulfuric acid and the like.

As used herein, the term “attached,” or any conjugation thereof describes and refers to the at least partial connection of two items.

As used herein, the term “polypak,” or any conjugation thereof may refer to multi-purpose seals that are molded, multi-purpose sealing devices combining an O-Ring type O-spring with a conventional lip seal.

### Embodiments

The embodiments of the invention relate to diaphragm actuators. The diaphragm can be formed from stainless steel and homogeneous type rubber supported by a nylon cloth bonded to the rubber. The nylon can prevent tension movement of the homogeneous portion of the diaphragm. Additionally, the nylon can prevent deformation of the diaphragm geometry. Diaphragms used herein can be generally round in shape. In certain embodiments, stainless steel or a metal may not be used in construction of the diaphragm itself. Preferably, the diaphragm is made of nitrile laminated with several layers of nylon. Layers of nylon have an advantage of experiencing less wear from friction.

As is typical with certain diaphragms, the center of the diaphragm, where the top shaft is positioned through the diaphragm towards the diaphragm retainer plate, the diaphragm may have a ring made of a substantially rigid substance such as a plastic, a ceramic or a metal which is molded into or otherwise permanently affixed to the diaphragm.

Regarding the diaphragm retainer plate, in the embodiments of the invention as described herein, the diaphragm rests upon a diaphragm retainer plate having a distal side oriented toward the diaphragm and a proximal side oriented toward an operator shaft such that movement of the diaphragm and diaphragm retainer plate in a proximal direction or distal direction normally results in movement of the operator shaft and hence a gate valve in a proximal direction or distal direction.

In typical implementation, a diaphragm actuator is mounted onto a bonnet and connected to a gate valve. The gate valve is typically connected to pipeline for the transport of fluid such as hydrocarbon gas, oil and the like. To open or close the gate, typically a diaphragm actuator is pressurized or depressurized. As will be apparent from the illustrations, a diaphragm actuator has a closed chamber subject to pressure changes and an unpressurized chamber. The closed chamber is the distal side of the diaphragm to the upper actuator housing. The unpressurized chamber is the proximal side of the diaphragm to the bonnet.

Further, in typical implementation, when pressure from a fluid enters the upper actuator housing, the pressure in the upper actuator housing pushes proximally on the diaphragm, resulting in a force being exerted on the diaphragm retainer plate, the top shaft and the operator shaft in a proximal direction. When such a diaphragm actuator is mounted upon a gate valve, this action results in opening or closing of the valve, depending on configuration. However, in certain instances, the diaphragm may have been stretched from use or the diaphragm may be an incorrect size for the diaphragm actuator, while still being capable of being installed. In such instances, if the diaphragm is large or is stretched, when pressure is applied to the diaphragm, it can wrap around the diaphragm retainer plate. This effectively prevents the diaphragm retainer plate, the top shaft and the operator shaft from moving in a proximal direction. Thus there is no change in either opening or closing the valve.

The embodiments herein provide an effective solution to this aforementioned problem when a properly fitted or un-stretched diaphragm is unavailable such as in remote locations. More specifically, the embodiments herein may allow a user in the field to adjust the thickness of the diaphragm retainer plate to avoid the aforementioned problems by taking apart the diaphragm actuator or by inserting simple tools into the diaphragm actuator to adjust said thickness.

In certain embodiments, the diaphragm retainer plate curves proximally at its outward edge, which is the edge opposite the location of the central axis comprised of the top shaft and the operator shaft. Further, in such embodiments, the diaphragm retainer plate may be considered to have a diaphragm retainer plate wall extending proximally from the outward edge of the diaphragm retainer plate. In some embodiments, the diaphragm retainer plate wall may be a continuous substantially circular wall around the diaphragm retainer plate. In other embodiments, the diaphragm retainer plate wall may be a series of discontinuous walls, which when taken together form a substantially circular shape around the diaphragm retainer plate

In such embodiments, the diaphragm retainer plate wall may have an inwardly threaded, which is adapted to receive an extender ring with an outwardly threaded wall. In other embodiments, the diaphragm retainer plate wall may be inwardly facing and smooth and adapted to receive a smooth outwardly facing extender ring such that the extender ring abuts the inwardly facing diaphragm retainer plate wall.

In certain additional embodiments concerning the extender ring, the extender ring may have a plurality of vertically grouped bores perpendicular to the central axis which align with a plurality of retainer plate wall bores which are perpendicular to the diaphragm retainer plate and are aligned at least one extender ring bore and adapted to receive a screw, bolt or pin extending outwardly from the inner surface of the extender ring to the retainer plate wall bore. The vertically grouped bores may align with the central axis or top shaft. Still further, in certain embodiments, in lieu of a plurality of vertically grouped bores, there may be a plurality of slits in the proximal to distal direction such that the extender ring is able to move in a proximal or distal direction followed by tightening of screws or bolts inserted from the inward side of the extender ring and into the retainer plate wall bores.

In certain further embodiments concerning either the aforementioned threaded or smooth extender ring, the ring, at its proximal end, may further comprise a lip extending outwardly such that the extender ring has a circumference at its proximal end approximately equal to the circumference of the diaphragm retainer plate.

In certain other embodiments, an alternate extender ring with a diameter about equal to the outward edge of the diaphragm retainer plate may be used. In such embodiments, the alternate extender ring has vertical extender bores oriented in a proximal to distal direction which are aligned with one or more vertical retainer wall threaded bores on the proximal end of the diaphragm retainer plate wall oriented in a proximal to distal direction. In such an embodiment, vertical bolts can be inserted into the vertical extender ring bores and into the vertical retainer wall threaded bores. Such a configuration would allow the movement of the alternate extender ring to move from a distal position to a more proximal position and back depending on the tightening or loosening of the vertical bolts.

In a further embodiment, the diaphragm retainer plate may have a threaded outwardly facing wall designed to accept an inwardly facing threaded wall from a diaphragm retainer plate ring having a distal end and a proximal end. Such a ring could extend above or below or both above and below the diaphragm retainer plate and be capable of moving in a proximal or distal direction by rotation. In such an embodiment, the diaphragm retainer plate ring would serve a function similar to the use of an extender ring in increasing or decreasing the distance between the distal side of the diaphragm retainer plate and the proximal end of the diaphragm retainer plate ring.

In still further embodiments, wherein a diaphragm retainer plate ring is contemplated, the diaphragm retainer plate may have an outwardly facing smooth wall designed to abut an inwardly facing smooth wall from a diaphragm retainer plate ring. In such embodiments, the outward edge of the diaphragm retainer plate may have horizontal threaded bores capable of aligning with a series of horizontal threaded bores in a distal to proximal position on a diaphragm retainer ring. In such embodiments, there may be several series of horizontal bores in a distal to proximal position, such as at a 12 O'clock position, a 3 O'clock position, a 6 O'clock position, and a 9 O'clock position when the diaphragm retainer ring and diaphragm retainer plate are viewed from above such that the distal side of the diaphragm retainer plate is seen. In such embodiments, the diaphragm retainer ring may have bolts traversing at least one of the horizontal bores from the outward side to the inward side. Then said bolts would be designed to be received by the aforementioned horizontal threaded bores. Such positioning would allow adjustment of the diaphragm retainer ring in a proximal or distal direction relative to the diaphragm retainer plate.

In other similar embodiments, in lieu of several series of horizontal bores at certain positions on the diaphragm retainer ring, there may be several slots oriented in a proximal to distal direction from the outward side of the diaphragm retainer plate ring to the inward side of the diaphragm retainer plate ring. In such embodiments, the diaphragm retainer ring may have bolts traversing the slots from the outward side to the inward side. Then said bolts would be designed to be received by the aforementioned horizontal threaded bores. Such positioning would allow adjustment of the diaphragm retainer ring in a proximal or distal direction relative to the diaphragm retainer plate. After the diaphragm retainer ring is properly adjusted, the bolts would be tightened to secure the ring in place.

Configuration

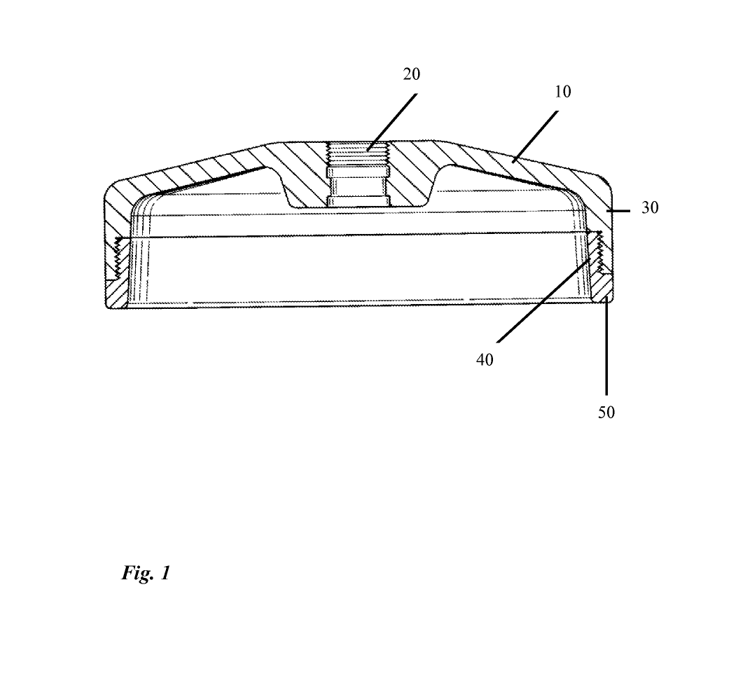

Referring now to FIG. 1, a cross sectional illustration of a diaphragm retainer plate of the present invention is depicted. As shown in FIG. 1 the diaphragm retainer plate 10 curves proximally at its outward edge, which is the edge opposite the location of the central axis comprising at least the top shaft. As can be further seen in FIG. 1, the diaphragm retainer plate 10 has a top shaft threaded bore 20 in the diaphragm retainer plate for receiving a top shaft. Further, the diaphragm retainer plate may be considered to have a diaphragm retainer plate wall 30 extending proximally from the outward edge of the diaphragm retainer plate 10. As viewed in FIG. 1, the diaphragm retainer plate wall 30 is a substantially circular wall around the diaphragm retainer plate 10. Still further, FIG. 1 illustrates that the diaphragm retainer plate wall 30 has a threaded inward facing wall, which is adapted to receive an extender ring 40 with an outwardly facing threaded wall. Rotation of the extender ring 40 relative to the diaphragm retainer plate wall 30 moves the extender in a proximal or distal direction. Also seen is a lip 50 at the proximal end of the extender ring such that at the proximal end of the extender ring, the lip 50 has a circumference at its proximal end approximately equal to the circumference of the diaphragm retainer plate 10.

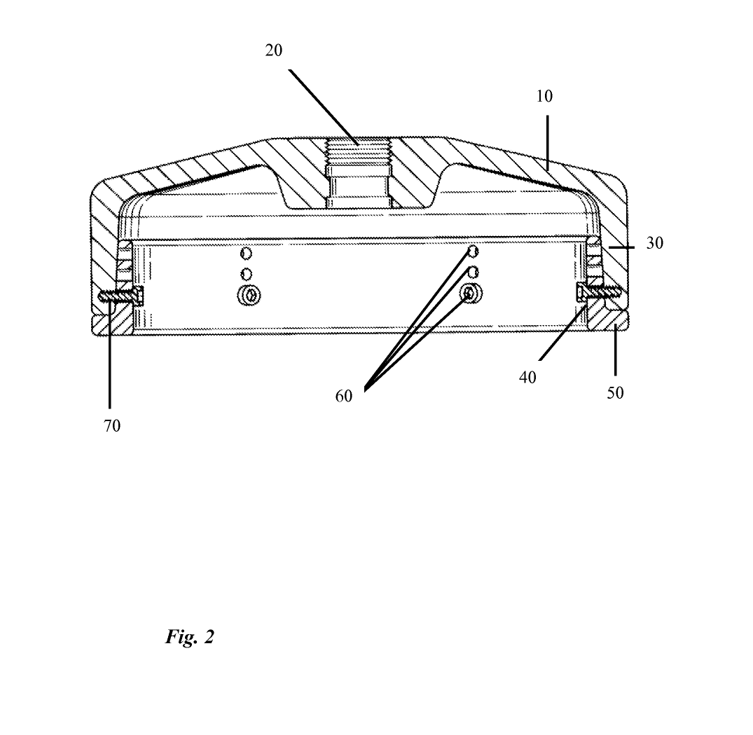

Referring now to FIG. 2, another cross sectional illustration of the present invention is depicted. As shown in FIG. 2, the diaphragm retainer plate 10 curves proximally at its outward edge, which is the edge opposite the location of the central axis comprising at least the top shaft. As can be further seen in FIG. 2, the diaphragm retainer plate 10 has a top shaft threaded bore 20 in the diaphragm retainer plate for receiving a top shaft. Further, the diaphragm retainer plate may be considered to have a diaphragm retainer plate wall 30 extending proximally from the outward edge of the diaphragm retainer plate 10. As viewed in FIG. 2, the diaphragm retainer plate wall 30 is a substantially circular wall around the diaphragm retainer plate 10. Still further, FIG. 2 illustrates that the diaphragm retainer plate wall 30 has a smooth inward facing wall, which is adapted to receive an extender ring 40 with an outwardly facing smooth wall. Still further, in this embodiment, the extender ring 40 may have a plurality of vertically grouped bores 60 perpendicular to the central axis which align with a plurality of retainer plate wall bores 70. While each bore within each of the vertically grouped bores 60 is adapted to receive a bolt, screw or pin, which then will enter the a retainer plate wall bore 70, only one bore within each group of the vertically grouped bores 60 will actually receive a bolt, screw or pin such that the extender ring 40 can move in a proximal or distal direction. Like the extender ring 40 in FIG. 1, the extender ring 40 in FIG. 2 possesses a lip 50 at the proximal end of the extender ring such that at the proximal end of the extender ring, the lip 50 has a circumference at its proximal end approximately equal to the circumference of the diaphragm retainer plate 10.

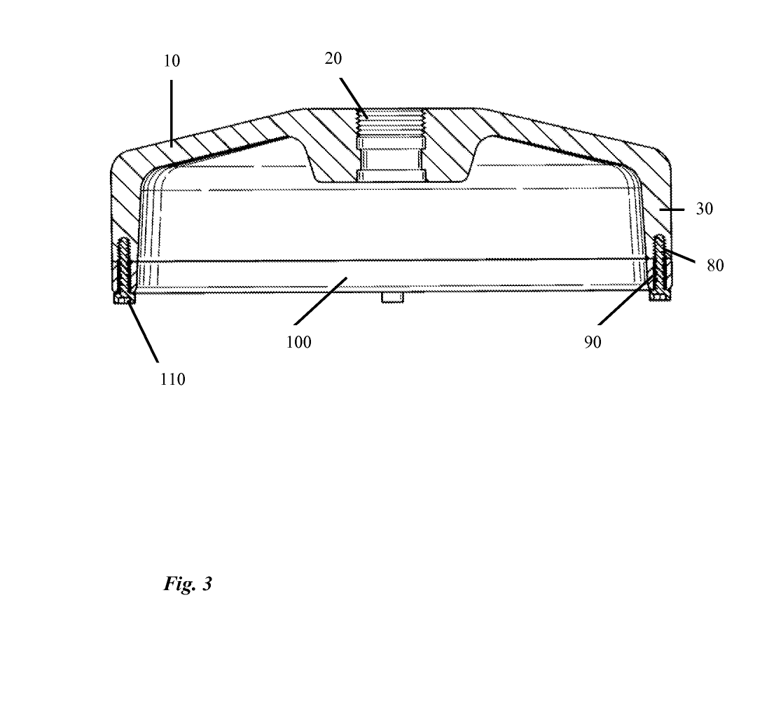

Referring now to FIG. 3, another cross sectional illustration of the present invention is depicted. As shown in FIG. 3, the diaphragm retainer plate 10 curves proximally at its outward edge, which is the edge opposite the location of the central axis comprising at least the top shaft. As can be further seen in FIG. 3, the diaphragm retainer plate 10 has a top shaft threaded bore 20 in the diaphragm retainer plate for receiving a top shaft. Further, the diaphragm retainer plate may be considered to have a diaphragm retainer plate wall 30 extending proximally from the outward edge of the diaphragm retainer plate 10. As viewed in FIG. 3, the diaphragm retainer plate wall 30 is a substantially circular wall around the diaphragm retainer plate 10. Further, the diaphragm retainer plate wall 30 has vertical retainer wall threaded bores 80. The vertical retainer wall threaded bores 80 are intended to align with vertical extender ring bores 90 located on an extender lip 100 located immediately proximal to the diaphragm retainer plate wall 30. However, unlike the previous extender rings, the alternate extender ring is the same circumference as the diaphragm retainer plate 10. As further depicted in FIG. 3, vertical bolts 110 extend from the proximal side of the extender lip 100, through the vertical extender ring bores 90 and into the vertical retainer wall threaded bores 80. By loosening or tightening the vertical bolts 110, the extender lip 100 can be moved in a proximal or distal direction relative to the diaphragm retainer plate 10.

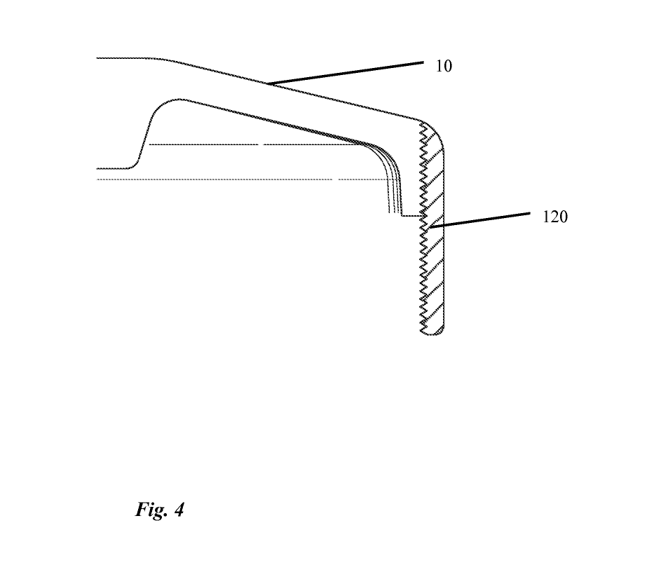

Referring to FIG. 4, another embodiment of the present invention is depicted. In this embodiment the diaphragm retainer plate 10 has a threaded outwardly facing wall designed to accept an inwardly facing threaded wall from a diaphragm retainer plate ring 120 having a distal end and a proximal end. The diaphragm retainer plate ring 120 is capable of extending above or below or both above and below the diaphragm retainer plate 10 and be capable of moving in a proximal or distal direction by rotation.

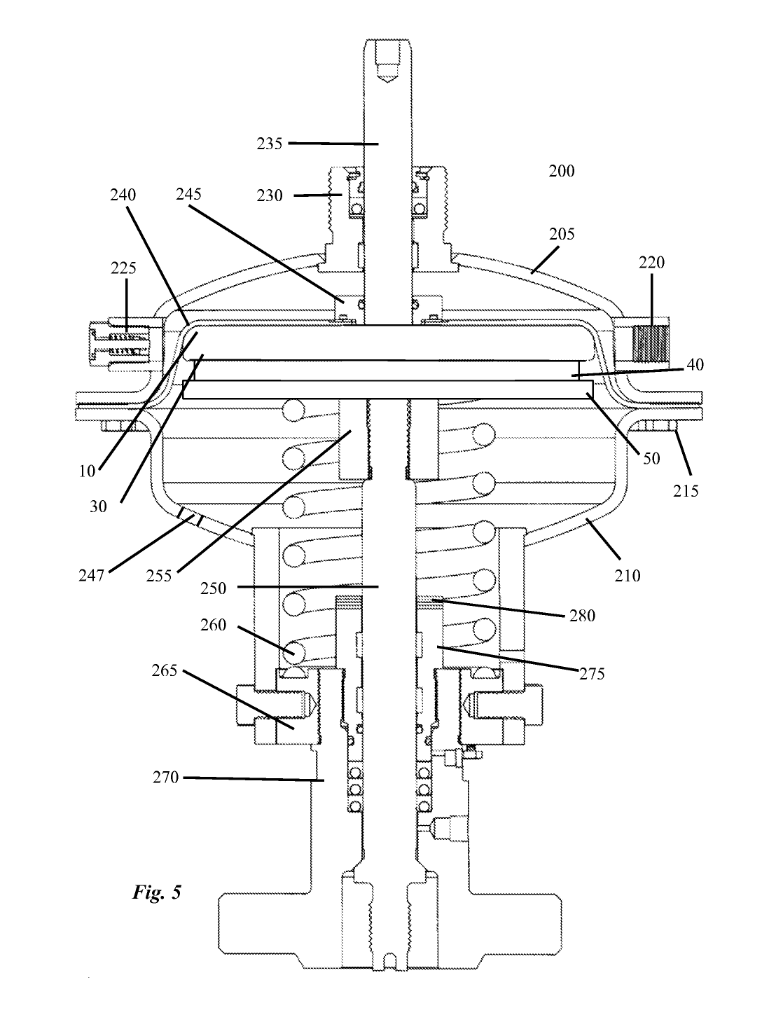

Referring to FIG. 5, the actuator 200 has a top actuator housing 205 and a lower actuator housing 210. The top actuator housing is distal to the lower actuator housing and is bolted to the distal end of the lower actuator housing via a series of actuator bolts 215. Further, the top actuator housing 205 has a port for increasing or decreasing pressure hereafter referred to as an inlet port 220. The top actuator housing further comprises a pressure relief valve 225. At the distal end of the top actuator housing 205 is an upper plug 230 which is welded, cast, forged or screwed into the top actuator housing. The upper plug 230 has an internal bore for receiving a top shaft 235. Further, the upper plug 230 has a group of seals to keep pressure from escaping the top actuator housing 205. These components may be made of hard plastic like materials such as delrin, nylon, thermoplastics, resins, polyurethanes, phenolics, acetals, polyacrylates, epoxides, polycarbonates, polyester, aramids and the like.

Typically, unless noted otherwise, the components of the actuator are made of stainless steel.

The top shaft 235 fits through the upper plug 230 of the top actuator housing 205. The top shaft 235 has a proximal end pointed away from the diaphragm 240 and a distal end pointed toward the diaphragm 240. Further, the top shaft 235 is preferably formed from stainless steel. The top shaft 235 is preferably large enough in diameter to prevent bucking stresses when loaded by a manual override or a hydraulic override. The proximal end of the top shaft may be threaded directly into a diaphragm retainer plate 10 or a diaphragm retaining nut 245 may be threaded into the diaphragm retainer plate 10 to secure the top shaft 235.

As depicted in FIG. 5, the diaphragm 240 rests on the diaphragm retainer plate 10. Preferably the diaphragm 240 is made of nitrile laminated with several layers of nylon. Layers of nylon have an advantage of experiencing less wear from friction. Diaphragms may further include a stainless steel concentric insert seal ring bonded to the diaphragm which may come in contact with the diaphragm retaining nut 245. The diaphragm serves as a seal between the top actuator housing 205 and the lower actuator housing 210. Thus the area within the top actuator housing and the diaphragm can be considered to be a pressure chamber or a pressurizeable chamber and the area below or proximal to the diaphragm can be considered to be under atmospheric pressure, or an unpressurized chamber.

As can be seen, the diaphragm retainer plate 10 has a diaphragm retainer plate wall 30. A portion of the extender ring 40 of FIG. 1 or FIG. 2 can be seen at the proximal end of the diaphragm retainer plate wall. Further the lip 50 of the extender ring 40 can be seen. To rotate the extender ring 40 or reposition the screws or bolts extending from the vertically grouped bores 60 and into retainer plate wall bore 70 as exemplified in FIG. 1, 2, or 3, a tool such as a screwdriver may be inserted through the actuator access holes 247 as illustrated in FIG. 5. A user would then contact either the diaphragm retainer ring, the lip 50 of the extender ring 40, or the bolts or screws of the extender ring 40 depending on configuration. The extender ring or the diaphragm retainer ring could then be raised or lowered in a proximal or distal direction thus preventing a wrap around issue from the stretched or improperly sized diaphragm.

The diaphragm retainer plate may distally be connected with or abut an operator shaft 250. Alternatively, a downstop 255 may be connected to the proximal side of the diaphragm retainer plate or abut the proximal side of the diaphragm retainer plate 10. In such embodiments, the operator shaft 250 may be connected to the downstop 255. In other aspects of FIG. 5, a central spring 260 surrounds the operator shaft 250. Preferably, the distal end of the central spring 260 is in contact with a downstop 255. Preferably the proximal end of the central spring 260 is in contact with the bonnet ring 265. The external circumference of the bonnet ring abuts the lower actuator housing 210. The internal bore of the bonnet ring is threaded. Preferably, to secure the bonnet ring 265 to the lower actuator housing 210, the bonnet ring 265 may have a series of threaded holes of a defined circumference which are perpendicular to the operator shaft 250. Likewise, the lower actuator housing 210 may have a series of holes which are approximately the same circumference as the threaded holes of the bonnet ring 265. Bolts may be screwed into the threaded holes from the exterior of the lower actuator housing such that the lower actuator housing abuts the bonnet ring. Preferably the interface of the lower actuator housing with the bonnet ring is air tight.

As indicated previously, the internal bore of the bonnet ring is threaded. Threaded into the bonnet ring is the bonnet 270. Thus the actuator housing can be screwed onto the bonnet 270 via the bonnet ring 265. The tension on the central spring 260 can also be adjusted by rotating the actuator housing with respect to the bonnet. As illustrated in FIG. 5, the bonnet 270 comprises an internal bore. The distal portion of the internal bore is threaded so as to receive the packing retainer 275. The packing retainer 275 preferably surrounds the operator shaft 250. Distal to the internal packing retainer are drift shims 280. The drift shims 280 partially or completely surround the operator shaft 250. Drift shims 280 can be added or removed as required to increase or decrease the combined shim width.

The proximal end of the operator shaft 250 may be threaded to accept a valve gate so as to open and close a valve depending on whether the top housing 205 is pressurized, which would move the operator shaft 250 proximally.

The foregoing detailed disclosure and description of the invention is illustrative and explanatory thereof, and it will be appreciated by those skilled in the art, that various changes in the size, shape and materials as well as in the details of the illustrated construction, reliability configurations, or combination of features of the various valve actuator elements of the present invention may be made without departing from the spirit of the invention.

1. A diaphragm actuator with a top actuator housing connected to a lower actuator housing for moving a gate valve, wherein the valve actuator moves the gate between an opened and a closed position within a valve body, and wherein the valve actuator comprises:
a. a pressure chamber and an inlet port formed in the top actuator housing;
b. a top shaft, wherein the top shaft extends through the top actuator housing and is operatively connected to a diaphragm retainer plate, the top shaft defining a shaft axis;
c. a diaphragm that applies pressure against a diaphragm retainer plate, and wherein the diaphragm further comprising a pressure side that engages the diaphragm retainer plate, and an atmospheric side opposite the pressure side, the diaphragm at least partially surrounding the top shaft;
d. a diaphragm retainer plate with a proximal side, a distal side and having an outwardly facing edge defining a circumference;
e. a diaphragm retainer plate wall connected to the proximal side of the diaphragm retainer plate and at least partially wrapping around the circumference, the diaphragm retainer plate wall having a proximal end, an outwardly facing side and an inwardly facing side, the inwardly facing side being adapted to receive an extender ring;
f. an extender ring with a proximal end, a distal end, and an outwardly facing wall abutting the inwardly facing side of the diaphragm retainer plate wall; and
wherein extender ring is capable of moving in a proximal direction or distal direction relative to the diaphragm retainer wall and is capable of extending in a direction further proximal than the proximal end of the diaphragm retainer plate wall.

2. The diaphragm actuator of claim 1, wherein the inwardly facing wall of the diaphragm retainer plate wall is threaded and adapted to receive a threaded outwardly facing wall of the extender ring.

3. The diaphragm actuator of claim 2, wherein the extender ring moves in a proximal direction or distal direction relative to the diaphragm retainer plate wall by rotation of the extender ring.

4. The diaphragm actuator of claim 3, wherein a lip is attached to the proximal end of the retainer ring, the lip having a circumference about equal to the circumference of the diaphragm retainer plate.

5. The diaphragm actuator of claim 3, wherein the lower actuator housing has one or more access holes for insertion of a tool to rotate the extender ring.

6. The diaphragm actuator of claim 1, wherein the inwardly facing wall of the diaphragm retainer plate possesses threaded bores substantially perpendicular to the shaft axis and the inwardly facing wall is adapted to receive an outwardly facing wall of the extender ring.

7. The diaphragm actuator of claim 6, wherein the extender ring has a plurality of vertically grouped bores, with one bore of each group being capable of alignment with a threaded bore of the diaphragm retainer plate wall, and wherein the extender ring is capable of being secured to the diaphragm retainer plate wall by threaded bolts traversing at least one bore of the extender ring and being threaded into the threaded bore of the diaphragm retainer plate wall.

8. The diaphragm actuator of claim 7, wherein a lip is attached to the proximal end of the retainer ring, the lip having a circumference about equal to the circumference of the diaphragm retainer plate.

9. The diaphragm actuator of claim 6, the lower actuator housing has one or more access holes for insertion of a tool to move and secure the extender ring proximally or distally.

10. The diaphragm actuator of claim 6, wherein the extender ring has a plurality of vertical slits, with each slit being capable of alignment with a threaded bore of the diaphragm retainer plate wall, and wherein the extender ring is capable of being secured to the diaphragm retainer plate wall by threaded bolts traversing at least one slit of the extender ring and being threaded into the threaded bore of the diaphragm retainer plate wall and tightened until movement of the extender ring in a proximal or distal direction is inhibited.

11. The diaphragm actuator of claim 10, wherein a lip is attached to the proximal end of the retainer ring, the lip having a circumference about equal to the diaphragm retainer plate.

12. A diaphragm actuator with a top actuator housing connected to a lower actuator housing for moving a gate valve, wherein the valve actuator moves the gate between an opened and a closed position within a valve body, and wherein the valve actuator comprises:
a. a pressure chamber and an inlet port formed in the top actuator housing;
b. a top shaft, wherein the top shaft extends through the top actuator housing and is operatively connected to a diaphragm retainer plate, the top shaft defining a shaft axis;
c. a diaphragm that applies pressure against a diaphragm retainer plate, and wherein the diaphragm further comprising a pressure side that engages the diaphragm retainer plate, and an atmospheric side opposite the pressure side, the diaphragm at least partially surrounding the top shaft;
d. a diaphragm retainer plate with a proximal side, a distal side and having an outwardly facing edge defining a circumference;
e. a diaphragm retainer plate wall having a thickness and connected to the proximal side of the diaphragm retainer plate and at least partially wrapping around the circumference, the diaphragm retainer plate wall having a proximal end, the proximal end having threaded bores extending distally into the thickness of the diaphragm retainer plate wall;
f. an extender lip abutting the diaphragm retainer plate wall, the extender lip having a proximal side, a distal side, and extender lip bores extending from the proximal side of the extender lip to the distal side of the extender lip, wherein the bores are in alignment with the threaded bores of the diaphragm retainer plate wall; and
wherein threaded bolts extend through the extender lip bores and into the threaded bores of the diaphragm retainer plate wall, thereby securing the distal side of the extender lip to the proximal end of the diaphragm retainer plate wall.

13. The diaphragm actuator of claim 10, wherein the threaded bolts are loosened and the extender plate moves to a more proximal location thereby no longer abutting the diaphragm retainer plate wall.

14. A method for preventing a diaphragm in a diaphragm actuator from inhibiting movement of a diaphragm retainer plate when the actuator is pressurized, the method comprising one of the following:
a. installing a diaphragm retainer plate with a proximal side and a distal side into a diaphragm actuator, the diaphragm retainer plate having an outwardly facing edge defining a circumference; installing a diaphragm retainer plate wall connected to the proximal side of the diaphragm retainer plate and at least partially wrapping around the circumference, the diaphragm retainer plate wall having a proximal end, an outwardly facing side and an inwardly facing side, the inwardly facing side being adapted to receive an extender ring; and installing an extender ring with a proximal end, a distal end, and an outwardly facing wall abutting the inwardly facing side of the diaphragm retainer plate wall; or
b. installing a diaphragm retainer plate with a proximal side, a distal side and having an outwardly facing edge defining a circumference; installing a diaphragm retainer plate wall having a thickness and connected to the proximal side of the diaphragm retainer plate and at least partially wrapping around the circumference, the diaphragm retainer plate wall having a proximal end, the proximal end having threaded bores extending distally into the thickness of the diaphragm retainer plate wall; installing an extender lip abutting the diaphragm retainer plate wall, the extender lip having a proximal side, a distal side, and extender lip bores extending from the proximal side of the extender lip to the distal side of the extender lip, wherein the bores are in alignment with the threaded bores of the diaphragm retainer plate wall and the extender and threaded bolts extend through the extender lip bores and into the threaded bores of the diaphragm retainer plate wall, thereby securing the distal side of the extender lip to the proximal end of the diaphragm retainer plate wall; or
c. installing a diaphragm retainer plate with a proximal side and a distal side and with a threaded outwardly facing wall, the wall adapted to receive a retainer ring with a threaded inwardly facing wall, wherein rotation of the retainer ring moves the retainer ring in a proximal or distal direction relative to the diaphragm retainer plate.

15. The method of claim 14, wherein if the diaphragm is contacting the proximal side of the diaphragm retainer plate upon pressurization and the actuator possesses an extender ring, the method further comprises depressurizing the actuator, moving the extender ring proximally and repressurizing the actuator.

16. The method of claim 15, wherein upon repressurizing the actuator, the diaphragm no longer contacts the proximal side of the diaphragm retainer plate, thereby allowing the diaphragm retainer plate to move in a proximal direction.

17. The method of claim 14, wherein if the diaphragm is contacting the proximal side of the diaphragm retainer plate upon pressurization and the actuator possesses an extender lip, the method further comprises depressurizing the actuator and rotating the threaded bolts such that the extender lip moves in a proximal direction away from the diaphragm retainer plate wall, and repressurizing the actuator.

18. The method of claim 17, wherein upon repressurizing the actuator, the diaphragm no longer contacts the proximal side of the diaphragm retainer plate, thereby allowing the diaphragm retainer plate to move in a proximal direction.

19. The method of claim 14, wherein if the diaphragm is contacting the proximal side of the diaphragm retainer plate upon pressurization and the actuator possesses a retainer ring, the method further comprises depressurizing the actuator, rotating the retainer ring such that the retainer ring moves in a proximal direction, and repressurizing the actuator.

20. The method of claim 19, wherein upon repressurizing the actuator, the diaphragm no longer contacts the proximal side of the diaphragm retainer plate, thereby allowing the diaphragm retainer plate to move in a proximal direction.
